(19) United States
(12) Patent Application Publication
(10) Pub. No.: US 2012/0320252 A1
(43) Pub. Date: Dec. 20, 2012

(54) INTEGRATING A LIGHT IMAGING SYSTEM WITHIN A MOBILE DEVICE TO IMAGE A DIGITAL FILE AND SEND THE IMAGE TO A RECEPTOR SURFACE

(75) Inventor: Leigh M. Rothschild, Sunny Isles Beach, FL (US)

(73) Assignee: ARIEL INVENTIONS LLC, Sunny Isles Beach, FL (US)

(21) Appl. No.: 13/525,339

(22) Filed: Jun. 17, 2012

Related U.S. Application Data
(60) Provisional application No. 61/498,334, filed on Jun. 17, 2011.

(51) Int. Cl. H04N 5/225

(52) U.S. Cl. 348/340; 348/E05.024

(57) ABSTRACT

Systems, methods and devices for rendering a digital image on a receptor surface. Embodiments include capturing an image of the receptor surface using an image sensor and determining a distance from a light imaging system to the receptor surface. Further, an image processing application analyzes the captured image of the receptor surface to determine boundaries of the receptor surface. In addition, the light imaging system projects the digital image on the receptor surface based on the distance and the boundaries of the receptor surface.

### CROSS-REFERENCE TO RELATED APPLICATIONS

The present application claims priority under the laws and rules of the United States, including 35 USC §120, to U.S. Provisional Patent Application No. 61/498,334 filed Jun. 17, 2011. The contents of U.S. Provisional Patent Application No. 61/498,334 filed Jun. 17, 2011 are herein incorporated by reference in its entirety.

### BACKGROUND

Modern applications of mobile devices including mobile phones, smartphones, and tablet computers include accessing and viewing digital files. Such files include images captured by a camera coupled to the mobile device as well as text documents that may be email attachments. Further, a user may like to view digital images and text documents stored in the mobile device or accessed from a remote computer server. The current state of the art allows a mobile device to view the digital images or the text documents on the display of the mobile device. However, the quality of the displayed image and the size rendered on the mobile device display may cause the user difficulty in discerning aspects of the image. Thus, a need exits for a user of a mobile device to be able to view a larger and increased quality rendition of an image. Further, a need exists for a user of the mobile device to render an image temporarily or permanently on a receptor surface such as printer paper.

Current portable projection devices use laser or LED light sources to project images on a screen. However, these devices render the image on the screen only while the portable projection device is in use.

Further, current laser/LED printers render an image onto printer paper using a laser/LED light source, toner, a printer drum, and a fuser. The printer drum is electrostatically charged and the light from the laser/LED light source discharges areas of the printer drum based on the image to be rendered. As the printer paper is rolled around the printer drum, the printer paper is electrostatically charged. Further, a toner cartridge dispenses toner such that the toner adheres to the electrostatically charged paper based on the image to be rendered. The fuser provides a heat source that permanently renders the toner to the printer paper. Thus, a need exists for a portable laser imaging system coupled to a mobile device that can render an image temporarily or permanently onto a receptor surface such as printer paper.

In addition, photoluminescent material reacts with a laser/LED light source to render a temporary or permanent image. Photoluminescence is a process in which a substance absorbs photons (electromagnetic radiation) and then emits photons to cause luminescence. That is, the photoluminescent material absorb light (electromagnetic radiation), then is excited to a high energy state followed by a transition to a lower energy state accompanied by an emission of a photon. The emission of the photon generates luminescence. Many chemicals can be used in photoluminescent materials, including phosphor, Gallium-Arsenide, and Indium Phosphide. Thus, a need exists to have photoluminescent materials react with the received light (e.g. laser, LED) to render an image permanently or temporarily from a portable laser imaging device coupled to a mobile device.

### BRIEF DESCRIPTION OF THE SEVERAL VIEWS OF THE DRAWINGS

The accompanying drawings, which are incorporated in and constitute part of this specification, illustrate embodiments of the invention and together with the description serve to explain the principles of the present disclosure. The embodiments illustrated herein are presently preferred, it being understood, however, that the present disclosure is not limited to the precise arrangements and instrumentalities shown, wherein:

FIG. 1 is exemplary network of devices that allow for a light imaging system coupled to a mobile device to project an image to a receptor surface;

FIG. 2 is exemplary light imaging system coupled to a mobile device to project an image to a receptor surface;

FIG. 3 is exemplary mobile device coupled to a light imaging system to project an image to a receptor surface; and

FIGS. 4A and 4B show an exemplary flowchart of an exemplary method that allows for a light imaging system coupled to a mobile device to project an image to a receptor surface.

### DETAILED DESCRIPTION

Embodiments of the present disclosure allow a user of a mobile device to project and image a page from a text document or image file onto a receptor surface. Such an embodiment may include the user displaying the selected page on the mobile device. The user then provides user input to cause the mobile device to image the document or file. The user may then provide a receptor surface which may be comprised of a chemically or optically treated material. The receptor surface is placed onto a flat surface and the device would use imaging and computer software processing to measure the length and width of the receptor surface.

Further, the laser imaging system integrated into the mobile device is configured to render the image in a size (length and width) that would fit the confines of the receptor surface. The image can then be projected onto the receptor surface, and the receptor surface would then receive, process, and display a copy of the image on the receptor surface. Although embodiments describe the light source of the imaging system to be a laser, persons of ordinary skill in the art would understand that any other light source (e.g. LED) can be used in such light imaging system. Light from such a light source is able to react with the chemically or optically treated material on the receptor surface to render an image of the digital file.

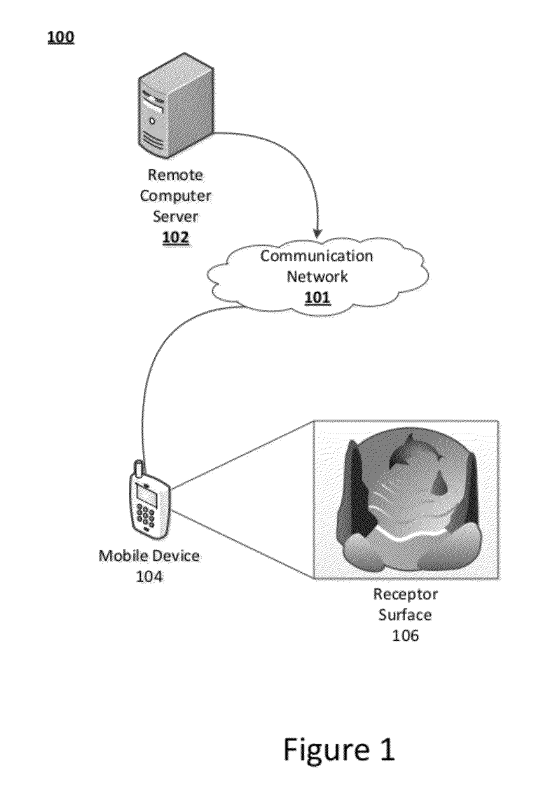

FIG. 1 is exemplary network of devices 100 that allow for a light imaging system coupled to a mobile device 104 to project an image onto a receptor surface. The network includes the mobile device 104 coupled to a communication network 101 such as the Internet and/or a wireless network. Further, the mobile device 104 is also coupled to a remote computer server 102 through the communication network 101. A user may access a digital image file from a storage device within the mobile device 104 or may access the digital image file from the remote computer server 102. The remote computer server 102 may be part of an Internet photography service such as Flicker, Picassa, etc. Alternatively, the remote computer server may be part of a social networking service such as Facebook, Google +, Myspace, Twitter, LinkedIn, etc. Further, the remote computer server 102 may be part of a cloud computing service such as iCloud, Google Docs, etc.

A light imaging system may be coupled or integrated into the mobile device 104. An image sensor that is part of the light imaging system detects and captures an image of the receptor surface 106. The computer processing that is part of the lighting imaging system within the mobile device analyzes the image of the receptor surface and identifies its discernible boundaries (or x and y coordinates, where x is the length of the receptor surface and y is the width of the receptor surface). The computer processing can estimate the distance between the mobile device/light imaging system and the receptor surface by determining the time delay of the light beam that is used for the image projection and which is reflected from the receptor surface. By analyzing the projection distance and the size and position of the boundaries of the receptor surface the image processing software application can then set the projection and imaging parameters for the light imaging system, so the projected image is scaled and aligned to the boundaries of the receptor surface.

Once the computer processing analyzes the captured image of the receptor surface 106, the light imaging system uses the analysis to project an image of the digital image file onto a receptor surface 106. The receptor surface 106 is comprised of chemically or optically treated material that reacts to the light source so as to render the digital image file onto the receptor surface.

The receptor surface 106 can be made of different materials such as toner treated paper or photoluminescent material to render an image. Traditional laser/LED printers use a toner cartridge to dispense toner onto printer paper. Toner includes dry carbon power mixed with plastic polymer particles that are electrically charged and then heated, causing the toner to adhere to the printer paper. Thus, the receptor surface 106 may incorporate a toner film adhered to electrostatically charged paper or material. Thus, when the receptor surface 106 receives the light, areas corresponding to the image are electrostatically discharged and heated such that the toner adheres to the paper or material. Thus, the receptor surface 106 reacts to the received light (e.g. laser, LED, etc.) to render the image temporarily or permanently on the receptor surface 106.

The receptor surface 106 may also include photoluminescent material. Photoluminescence is a process in which a substance absorbs photons (electromagnetic radiation) and then emits photons to cause luminescence. That is, the photoluminescent material absorb light (electromagnetic radiation), then is excited to a high energy state followed by a transition to a lower energy state accompanied by an emission of a photon. The emission of the photon generates luminescence. Many chemicals can be used in photoluminescent materials, including phosphor, Gallium-Arsenide, and Indium Phosphide. Thus, the receptor surface 106 can include such photoluminescent materials that react with the received light (e.g. laser, LED) to render an image permanently or temporarily on the receptor surface 106.

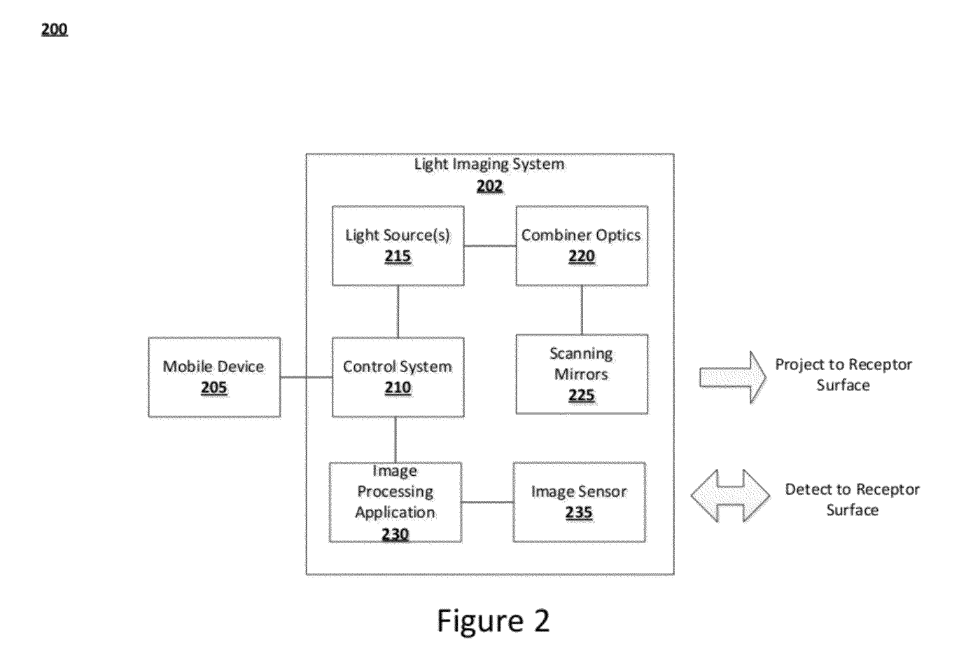

FIG. 2 is exemplary light imaging system 202 coupled or integrated with a mobile device to project an image to a receptor surface. The light imaging system 202 includes a control system 210, one or more light sources 215, combiner optics 220, scanning mirrors 225, image sensor 235, and an image processing software application 230.

The control system 210 receives instructions from the mobile device 210 to project an image of a digital file onto the receptor surface. The control system 210 may then provide instructions to the image sensor 235 to capture the image of the receptor surface and forward the captured image to the image processing software application 230 to be analyzed. Image sensors include charged coupled diodes and CMOS sensors of various formats and producing various image resolutions. The image processing software application 230 analyzes the image of the receptor surface and identifies its discernible boundaries (or x and y coordinates, where x is the length of the receptor surface and y is the width of the receptor surface).

For example, the receptor surface may be of white material and is resting on a black background surface. The image sensor is able to discern the boundaries of the receptor surface using current state of the art image processing techniques. In another example, the receptor surface of white material can be resting on a white background surface. Current state of the art image processing techniques can discern the boundaries of the receptor surface due to the change is texture of the image caused by the edges of the receptor surface resting on the white background surface.

The image processing software application 230 can estimate the distance between the mobile device/light imaging system and the receptor surface by determining the time delay of the light beam that is used for the image projection and which is reflected from the receptor surface. By analyzing the projection distance and the size and position of the boundaries of the receptor surface, the image processing software application 230 can then set the projection and imaging parameters for the light imaging system, so that the projected image is scaled and aligned to the boundaries of the receptor surface. The projection distance and the size and position of the boundaries of the receptor surface can be forwarded to the control system 210.

The control system 210 receives the digital file to be rendered to the receptor surface from the mobile device 205. The control system 210 includes an integrated digital circuit to convert the image of the digital file into digital electronic signals. Further, the electronic signals drive the one or more light sources 215, each light source emitting a colored light with a different intensity along a different light path. The combiner optics 220 can receive, combine, and filter or separate the different light paths into one light path exhibiting a palette of colors. Scanning minors 225 receive the light path from the combiner optics and copy the image pixel-by-pixel and then project the image onto the receptor surface. The receptor surface is comprised of chemically or optically treated material that reacts to the light from the one or more light sources and can temporarily or permanently render the image onto the receptor surface.

The embodiment shown and discussed in FIG. 2 is described to be integrated with the mobile device 205 such as a smartphone or tablet computer. This in such an embodiment the distance between the light imaging system and the receptor surface would be substantially similar to the distance between the mobile device and the receptor surface. However, other embodiments may include the light imaging system to be a separate device that can be coupled to the mobile device 205 using wireless connection (e.g. WiFi, Bluetooth, etc.) or wired connection (e.g. Firewire, USB, etc.) In such embodiments, the

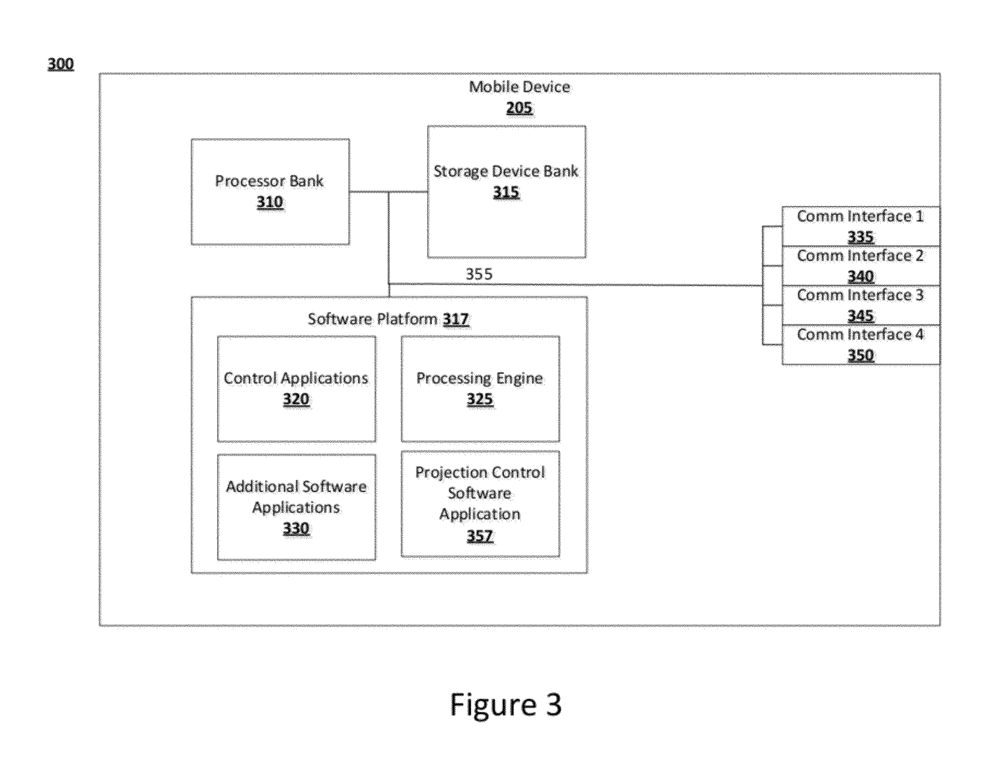

FIG. 3 is exemplary mobile device 205 coupled to a light imaging system to project an image to a receptor surface 300. A mobile device 205 includes, but is not limited to, a processor bank 310, a storage device bank 315, a software platform 317, and one or more communication interfaces (335-350).

The processor bank 310 may include one or more processors that may be co-located with each other or may be located in different parts of the requesting mobile device 205. The storage device bank 315 may include one or more storage devices. Types of storage devices may include memory devices, electronic memory, optical memory, internal storage media, and/or removable storage media. The one or more software platform 317 may include a processing engine 325, control software applications 320, additional software applications 330, and projection control software application 357. Further, the control and additional software applications 320 and 330 may include control software applications that implement software functions that assist in performing certain tasks for the mobile device 205 such as providing access to a communication network, executing an operating system, managing software drivers for peripheral components, and processing information. In addition, the control and additional software applications 320 and 330 may also include software drivers for peripheral components, user interface computer programs, debugging and troubleshooting software tools. Also, the control and additional software applications 320 and 330 may include an operating system supported by the remote server. Such operating systems are known in the art for such a remote server but may also include computer and smartphone operating systems (e.g. Windows 7, Linux, Android, IOS UNIX, previous version of Windows and MacOS, etc.).

The processing engine 325, based on user input, may access and receive a digital file from the stored in memory in the storage device bank 315. This digital file may be an image file or a text document. Alternatively, the processing engine 325 may access and receive the digital file from a remote computer server through one of the communication interfaces (335-350) as described in FIG. 1. Such a remote computer server may be operated by an Internet photography service such as Flicker or Picassa, a social networking service such as Facebook, Google +, Myspace, Twitter, or LinkedIn, or a cloud computing service such as iCloud or Google Docs. Once received, the user may view the digital file on the display of the mobile device.

Further, the user may want to render an image of the digital file onto a receptor surface. Thus, the user may input instructions processed by the projection control software application 357 to cause the light imaging system integrated or coupled to the mobile device 205 to project an image of the digital file onto the receptor surface. Such instructions include capturing an image of the receptor surface and determining the size and boundaries of the receptor surface. The instructions further indicate to convert the digital file in an electronic signal to drive one or more light sources in the light imaging system and through combiner optics and scanning mirrors project and image the file onto the receptor surface.

Each of the communication interfaces (335-350) shown in FIG. 3 may be software, firmware or hardware associated in communicating to other devices. The communication interfaces (335-350) may be of different types that include a user interface, USB, Ethernet, WiFi, WiMax, wireless, optical, cellular, or any other communication interface coupled to a communication network.

An intra-device communication link 355 between the processor bank 310, storage device bank 315, software platform 317, and communication interfaces (335-350) may be one of several types that include a bus or other communication mechanism.

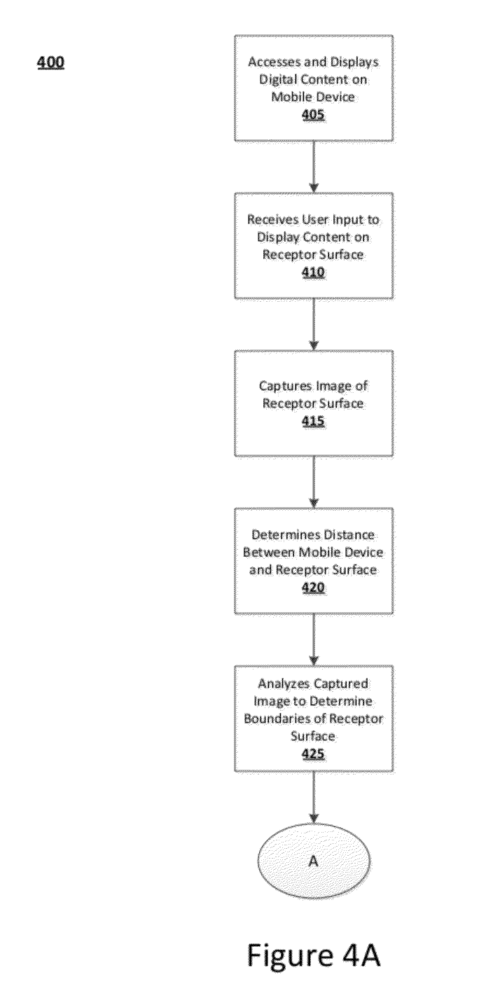

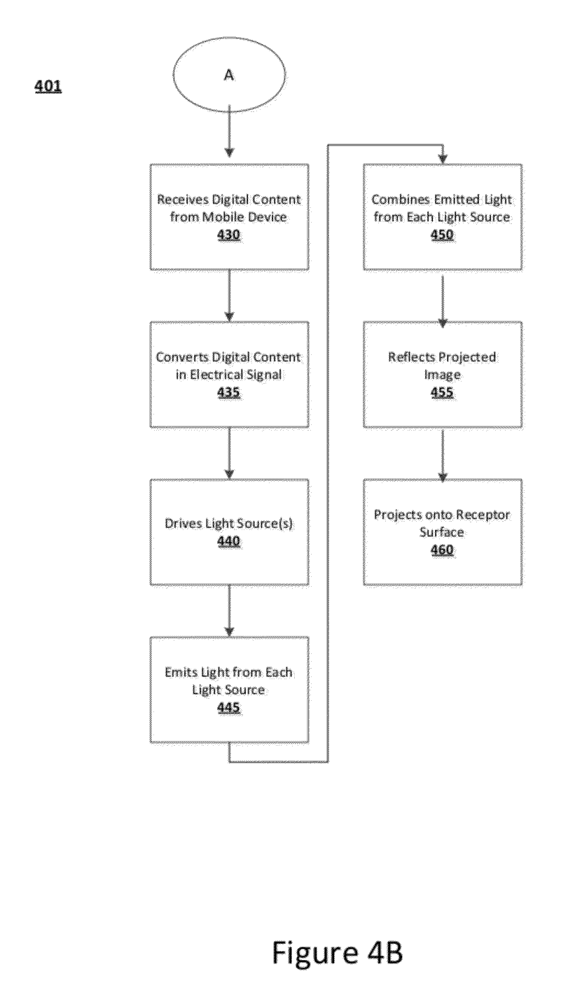

FIGS. 4A and 4B show an exemplary flowchart of an exemplary method (400 and 401) that allows for a light imaging system coupled to a mobile device to project an image to a receptor surface. Referring to FIG. 4A, the method includes a user accessing digital content with a mobile device and presenting the digital content on a display of the mobile device, as shown in block 405. The digital content can be a digital image file such as a JPEG, GIF, or BMP file, or alternatively, a text file such as a word processing, spreadsheet, presentation (e.g. Power Point).ppt)) or PDF file. The digital content can be accessed from a storage device coupled to the mobile device or from a remote computer server.

The method further includes the mobile device receiving user input to display the digital content on a receptor surface, as shown in block 410. The user input may be provided using a touchscreen, keyboard, mouse, gesture, voice recognition or a combination thereof. The method additionally includes capturing an image of the receptor surface using an image sensor, as shown in block 415. Image sensors include capture devices such as charged coupled diodes and CMOS sensors of various formats and producing various image resolutions. Moreover, the method includes determining a distance from the mobile device to the receptor surface, as shown in block 420, and analyzing the captured image of the receptor surface to determine boundaries of the receptor surface, as shown in block 425.

Referring to FIG. 4B, the method includes receiving the digital content by a light imaging system from the mobile device, as shown in block 425. The light imaging system includes a control system, one or more light sources, one or more combiner optics, and one or more scanning mirrors. Further, the light imaging system may be coupled to or integrated with the mobile device. The method further includes converting the digital image into an electrical signal by the control system, as shown in block 435. The control system may include an integrated digital control circuit that can be used to perform the conversion. Moreover, the method includes the control system driving one or more light sources using the electrical signal, as shown in block 440. The light sources may be laser light sources, LED light sources, or any other light source known by a person of ordinary skill in the art.

The method also includes the one or more light sources receiving the electrical signal and emitting light from each light source, as shown in block 445. Each light source may emit a different color light with a different intensity based on the electrical signal. The method further includes the combiner optics receiving the emitted light from each of the one or more light sources and combining the emitted light into a projected image of the digital content, as shown in bloc 450. Combiner optics may also filter or separate the light paths to render a more accurate projected image of the digital content. The method additionally includes the one or more scanning mirrors receiving the projected image and reflecting the projected image, as shown in block 455. Moreover, the method includes the laser system projecting the digital image on the receptor surface based on the distance and the boundaries of the receptor surface such that the digital content is rendered onto the receptor surface, as shown in block 460.

The receptor surface is comprised of chemically or optically treated material that reacts to the light from the one or more light sources (e.g. laser, LED, etc.) and can temporarily or permanently render the image onto the receptor surface. The mobile device can be selected from the group including of a mobile phone, tablet computer, laptop computer, notebook computer, and a combination thereof. The remote computer server is operated by an entity, which can be selected from the group including of Internet photographic service, social networking service, cloud computing service, and a combination thereof.

Persons of ordinary skill in the art would understand that the software applications described herein can be implemented a computer processor. Further, the methods disclosed herein may be implemented by a computer in software and/or stored in a computer readable medium.

Note that the functional blocks, methods, devices and systems described in the present disclosure may be integrated or divided into different combination of systems, devices, and functional blocks as would be known to those skilled in the art.

In general, it should be understood that the circuits described herein may be implemented in hardware using integrated circuit development technologies, or yet via some other methods, or the combination of hardware and software objects that could be ordered, parameterized, and connected in a software environment to implement different functions described herein. For example, the present application may be implemented using a general purpose or dedicated processor running a software application through volatile or non-volatile memory. Also, the hardware objects could communicate using electrical signals, with states of the signals representing different data.

It should be further understood that this and other arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components in any suitable combination and location.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for rendering a digital image on a receptor surface, the method comprising:
capturing an image of the receptor surface using an image sensor;
determining a distance from a light imaging system to the receptor surface;
analyzing the captured image of the receptor surface to determine boundaries of the receptor surface; and
projecting the digital image on the receptor surface based on the distance and the boundaries of the receptor surface.

2. The method of claim 1, further comprising:
receiving the digital image by the light imaging system, wherein the light imaging system includes a control system, one or more light sources, one or more combiner optics, and one or more scanning minors;
converting the digital image into an electrical signal by the control system;
driving one or more light sources using the electrical signal.

3. The method of claim 1, further comprising:
receiving the electrical signal by one or more light sources;
emitting light from each of the one or more light sources.

4. The method of claim 3, further comprising:
receiving the emitted light from each of the one or more light sources by the combiner optics;
combining the emitted light from each of the one or more light sources into a projected image of the digital image.

5. The method of claim 4, further comprising:
receiving the projected image by one or more scanning mirrors;
reflecting the projected image by the one or more scanning mirrors to be displayed on the receptor surface.

6. The method of claim 1, wherein the receptor surface includes a toner film coupled to an electrostatically charged material, the toner film and electrostatically charged material reacting to the light from the light imaging system to render the digital image on the receptor surface

7. The method of claim 1, wherein the receptor surface includes photoluminescent material that reacts to light from the light imaging system to render the digital image on the receptor surface.

8. The method of claim 2, wherein the distance from the mobile device to the receptor surface is measured by:
transmitting light from the light source to the receptor surface;
receiving the light reflected from the receptor surface;
measuring a time interval between transmitting the light and receiving the light;
determining the distance from the light imaging system to the receptor surface based on the time interval.

9. The method of claim 1, further comprising:
receiving the digital image from a remote computer server;
presenting the digital image on a display of the mobile device.

10. The method of claim 2, wherein the light imaging system is coupled to a mobile device.

11. A mobile device for rendering a digital image on a receptor surface, comprising:
at least one processor configured to initiate or perform:
capturing an image of the receptor surface using an image sensor;
determining a distance from a light imaging system to the receptor surface;
analyzing the captured image of the receptor surface to determine boundaries of the receptor surface;
projecting the digital image on the receptor surface based on the distance and the boundaries of the receptor surface.

12. The mobile device of claim 11, wherein:
the at least one processor is further configured to initiate or perform:
receiving the digital image by the light imaging system, wherein the light imaging system includes a control system, one or more light sources, one or more combiner optics, and one or more scanning minors;
converting the digital image into an electrical signal by the control system;
driving one or more light sources using the electrical signal.

13. The mobile device of claim 12, wherein:
the at least one processor is further configured to initiate or perform:
receiving the electrical signal by one or more light sources;
emitting light from each of the one or more light sources.

14. The mobile device of claim 13, wherein:
the at least one processor is further configured to initiate or perform:
receiving the emitted light from each of the one or more light sources by the combiner optics;
combining the emitted light from each of the one or more light sources into a projected image of the digital image.

15. The mobile device of claim 14, wherein:
the at least one processor is further configured to initiate or perform:
receiving the projected image by one or more scanning mirrors;
reflecting the projected image by the one or more scanning mirrors to be displayed on the receptor surface.

16. The mobile device of claim 11, wherein the receptor surface includes a toner film coupled to an electrostatically charged material, the toner film and electrostatically charged material reacting to the light from the light imaging system to render the digital image on the receptor surface

17. The mobile device of claim 11, wherein the receptor surface includes photoluminescent material that reacts to light from the light imaging system to render the digital image on the receptor surface.

18. The mobile device of claim 12, wherein the distance from the mobile device to the receptor surface is measured by:
transmitting light from the light source to the receptor surface;
receiving the light reflected from the receptor surface;
measuring a time interval between transmitting the light and receiving the light;
determining the distance from the light imaging device to the receptor surface based on the time interval.

19. The mobile device of claim 11, wherein:
the at least one processor is further configured to initiate or perform:
receiving the digital image from a remote computer server;
presenting the digital image on a display of the mobile device.

20. The mobile device of claim 12, wherein the light imaging system is coupled to the mobile device.
